(19) United States
(12) Patent Application Publication
(10) Pub. No.: US 2015/0254593 A1
(43) Pub. Date: Sep. 10, 2015

(54) STREAMLINED CREATION AND UTILIZATION OF REFERENCE HUMAN INTELLIGENCE TASKS

(71) Applicant: Microsoft Corporation, Redmond, WA (US)

(72) Inventors: Jorge R. Ramos Rinze, Vancouver (CA); Rajesh Patel, Woodinville, WA (US); Steven Shelford, Vancouver (CA); Yunling Wang, Redmond, WA (US)

(73) Assignee: Microsoft Corporation, Redmond, WA (US)

(21) Appl. No.: 14/203,513

(22) Filed: Mar. 10, 2014

(51) Int. Cl. G06Q 10/06; H04L 29/06

(52) U.S. Cl. CPC G06Q 10/06398; H04L 65/403; G06Q 10/06311

(57) ABSTRACT

Reference intelligence tasks are automatically generated for subsequent utilization in crowdsourced processing of intelligence tasks. Reference intelligence tasks are categorized into predetermined categories, including categories defined by an intended utilization of such intelligence tasks. A trusted set of workers are provided with intelligence tasks and, if a specified number of those trusted workers reach consensus as to what is an appropriate answer, then such an answer is a definitive answer. Conversely, if no consensus is initially reached, then additional trusted workers can be utilized to determine if, in combination, consensus can be reached. To frame categorization considerations by the trusted set of workers, they are provided with statistics relevant to categorizations. An automatic category assignment, or reassignment, can be performed if necessary. Additionally, a maximum amount of time by which the automatic generation of a set of reference intelligence tasks is to complete is, optionally, established.

### BACKGROUND

As an increasing number of people gain access to networked computing devices, the ability to distribute intelligence tasks to multiple individuals increases. Moreover, a greater quantity of people can be available to perform intelligence tasks, enabling the performance of such tasks in parallel more efficient, and increasing the possibility that individuals having particularized knowledge or skill sets can be brought to bear on such intelligence tasks. Consequently, the popularity of utilizing large groups of disparate individuals to perform intelligence tasks continues to increase.

The term “crowdsourcing” is often utilized to refer to the distribution of discrete tasks to multiple individuals, to be performed in parallel, especially within the context where the individuals performing the task are not specifically selected from a larger pool of candidates, but rather those individuals individually choose to provide their effort in exchange for compensation. Existing computing-based crowdsourcing platforms distribute intelligence tasks to human workers, typically through network communications between the computing devices implementing such crowdsourcing platforms, and each human worker's individual computing device. Consequently, the human workers performing such intelligence tasks can be located in diverse geographic regions and can comprise diverse educational and language backgrounds. Furthermore, the intelligence tasks that such human workers are being asked to perform are typically those that do not lend themselves to easy resolution by a computing device, and are, instead, tasks that require the application of human judgment. Consequently, it can be difficult to verify that the various diverse and disparate human workers, over which there is little control, are properly performing the intelligence tasks that have been assigned to them.

One mechanism for improving the quality of the results generated in response to intelligence tasks that have been crowdsourced to an undefined set of workers is to utilize intelligence tasks for which definitive answers or results have already been determined and established. Such intelligence tasks can then be utilized to train workers, evaluate workers, qualify workers, and detect disingenuous workers. Unfortunately, the generation of a set of intelligence tasks and corresponding definitive answers can be tedious and time-consuming, as well as expensive, since it can require the input of specialists whose time and skills are substantially more expensive than the workers to whom such intelligence tasks are being crowdsourced.

### SUMMARY

In one embodiment, a set of intelligence tasks with already known definitive answers, referred to as “reference intelligence tasks” can be automatically generated from among a larger set of intelligence tasks that can be provided by a task owner. The task owner can provide intelligence tasks that the task owner seeks to have crowdsourced, and automated mechanisms can automatically generate a reference set of intelligence tasks and can subsequently utilize such reference intelligence tasks to optimize the processing of the remainder of the intelligence tasks by human workers in a crowdsourcing context.

In another embodiment, the automated generation of reference intelligence tasks can automatically generate reference intelligence tasks in pre-determined categories, including categories defined by an intended utilization of such intelligence tasks, such as utilization for the purpose of training workers, qualifying workers, evaluating workers, and detecting disingenuous workers.

In yet another embodiment, a trusted set of workers can be provided with intelligence tasks and, if a specified number of those trusted workers reach consensus as to what is an appropriate answer for a specific intelligence task, then such an answer can be considered to be a definitive answer and can be accordingly associated with the intelligence task. Conversely, if a specified number of the trusted workers do not reach consensus, then additional trusted workers can be provided with the intelligence task to determine if, in combination with such additional trusted workers, consensus can be reached. Both the number of trusted workers to whom an intelligence task is initially given, and the number of additional trusted workers, can be pre-established.

In a further embodiment, a trusted set of workers can further be utilized to reach consensus as to categorizations for the determined reference intelligence tasks. To frame such considerations, by the trusted set of workers, the trusted set of workers can be provided with statistics relevant to the categorizations of the determined reference intelligence tasks, including statistics indicative of a quantity of reference intelligence tasks already assigned a particular category, and a total number of reference intelligence tasks that have been requested for such a category. If consensus as to the categorization of a reference intelligence task is not reached, or, alternatively, if the consensus estimate categorization of a reference intelligence task is suboptimal for purposes of completing the automatic generation of reference intelligence tasks, then an automatic category assignment, or reassignment, can be performed.

In a still further embodiment, limits can be imposed as to a maximum amount of time by which the automatic generation of a set of reference intelligence tasks is to complete, thereby enabling a task owner to preemptively learn if the intelligence tasks do not promptly converge to consensus answers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for automatically generating, and subsequently utilizing, reference intelligence tasks.

FIG. 2 is a mockup diagram of an exemplary user interface by which an automatic generation of reference intelligence tasks can be defined.

FIG. 3 is a flow diagram of an exemplary automatic generation of reference intelligence tasks; and

FIG. 4 is a block diagram of an exemplary computing device.

### DETAILED DESCRIPTION

The following description relates to the automatic generation of reference intelligence tasks, from among a greater set of intelligence tasks that are sourced from a task owner and which the task owner desires to be processed by human workers in a crowdsourcing context. Automated mechanisms can automatically generate a reference set of intelligence tasks and can subsequently utilize such reference intelligence tasks to optimize the processing of the remainder of the intelligence tasks by human workers. Additionally, the automated generation of reference intelligence tasks can automatically generate reference intelligence tasks in pre-determined categories, including categories defined by an intended utilization of such intelligence tasks, such as utilization for the purpose of training workers, qualifying workers, evaluating workers, and detecting disingenuous workers. A trusted set of workers can be provided with intelligence tasks and, if a specified number of those trusted workers reach consensus as to what is an appropriate answer for a specific intelligence task, then such an answer can be considered to be a definitive answer and can be accordingly associated with the intelligence task. Conversely, if a specified number of the trusted workers do not reach consensus, then additional trusted workers can be provided with the intelligence task to determine if, in combination with such additional trusted workers, consensus can be reached. Both the number of trusted workers to whom an intelligence task is initially given, and the number of additional trusted workers, can be pre-established. A trusted set of workers can further be utilized to reach consensus as to categorizations for the determined reference intelligence tasks. To frame such considerations, by the trusted set of workers, the trusted set of workers can be provided with statistics relevant to the categorizations of the determined reference intelligence tasks, including statistics indicative of a quantity of reference intelligence tasks already assigned a particular category, and a total number of reference intelligence tasks that have been requested for such a category. If consensus as to the categorization of a reference intelligence task is not reached, or, alternatively, if the consensus estimate categorization of a reference intelligence task is suboptimal for purposes of completing the automatic generation of reference intelligence tasks, then an automatic category assignment, or reassignment, can be performed. Additionally, limits can be imposed as to a maximum amount of time by which the automatic generation of a set of reference intelligence tasks is to complete, thereby enabling a task owner to preemptively learn if the intelligence tasks do not promptly converge to consensus answers.

The techniques described herein focus on crowdsourcing paradigms, where intelligence tasks are performed by human workers, from among a large pool of disparate and diverse human workers, that choose to perform such intelligence tasks. However, such descriptions are not meant to suggest a limitation of the described techniques. To the contrary, the described techniques are equally applicable to any human intelligence task processing paradigm, including paradigms where the human workers to whom intelligence tasks are assigned are specifically selected or employed to perform such intelligence tasks. Consequently, references to crowdsourcing, and crowdsource-based human intelligence task processing paradigms are exemplary only and are not meant to limit the mechanisms described to only those environments.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

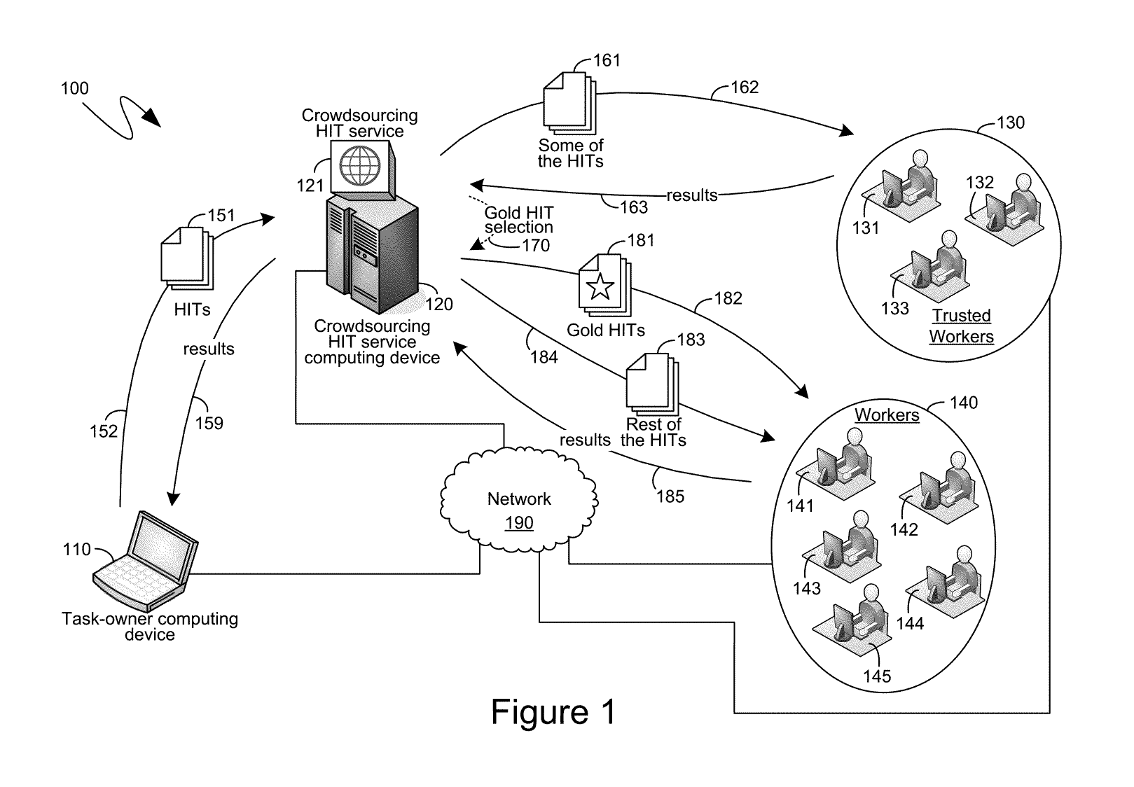

With reference to FIG. 1, an exemplary system 100 is illustrated, providing context for the descriptions below. As illustrated in FIG. 1, the exemplary system 100 can comprise a set of human workers 140, including the illustrated human workers 141, 142, 143, 144 and 145, and a trusted set of human workers 130, including the illustrated trusted human workers 131, 132 and 133. Although illustrated as separate sets, in the exemplary system 100 of FIG. 1, in other embodiments the trusted human workers 130, including the exemplary trusted human workers 131, 132 and 133, can be part of the human workers 140. Additionally, the exemplary system 100 of FIG. 1 can further comprise a crowdsourcing service 121 that can be executed by one or more server computing devices, such as the exemplary server computing device 120, and a task owner computing device, such as the exemplary task owner computing device 110 by which a task owner can interface with the crowdsourcing service 121 and utilize the crowdsourcing service 121 to obtain performance of human intelligence tasks by the human workers 140. The task owner computing device 110, the server computing devices on which the crowdsourcing service 121 executes, such as exemplary server computing device 120, and the computing devices of the trusted human workers 130 and human workers 140 can exchange computer-readable messages and can otherwise be communicationally coupled to one another through a network, such as the exemplary network 190 shown in FIG. 1.

Initially, as illustrated by the exemplary system 100 of FIG. 1, a task owner can upload human intelligence tasks (HITs), such as the exemplary intelligence tasks 151, to the crowdsourcing service 121, as represented by the communication 152 from the task owner computing device 110 to the exemplary server computing device 120 on which the crowdsourcing service 121 is executing. As will be recognized by those skilled in the art, and as utilized herein, the term “intelligence task” means a task whose result is to be generated by the application of human intelligence, as opposed to programmatic or machine intelligence. As will also be recognized by those skilled in the art, intelligence tasks are typically tasks that require the application of human evaluation or judging. For example, one intelligence task can be a determination of whether one specific web page is, or is not, relevant to one specific search term. Thus, a human worker performing such an intelligence task could be presented with a webpage directed to, for example, the aurora borealis, and a specific search term, such as, for example, “northern lights”, and such a human worker could be asked to determine whether or not the presented webpage is responsive to the presented search term.

An overall task can be composed of a myriad of such individual intelligence tasks. Consequently, returning to the above example, the task, owned by the task owner, that is comprised of such individual intelligence tasks, can be a determination of whether or not a collection of webpages is relevant to specific ones of a collection of search terms.

In one embodiment, as part of the communications 152, the task owner can instruct the crowdsourcing service 121 to automatically generate reference intelligence tasks that can be subsequently utilized to facilitate the crowdsourcing the intelligence tasks 151 that the task owner desires to have performed. As utilized herein, the term “intelligence task” means any task that requires the application of human intelligence to evaluate and thereby derive a result or answer to the task. Consequently, as utilized herein, the term “reference intelligence task” means any intelligence task for which a answer or result has already been determined and further that such an answer or result is considered to be the correct answer or result for the intelligence task. In industry parlance, the term “gold hit” is often utilized to refer to reference intelligence tasks. For ease of legibility and clarity, within the drawings, the shorthand term “gold hit” is used instead of the term “reference intelligence task”. Turning back to FIG. 1, in response to the above-referenced instruction from the task owner, the crowdsourcing service 121 can provide intelligence tasks, from among the intelligence tasks 151, to multiple ones of the trusted human workers 130, as illustrated by the communication 162. The trusted human workers 130 can be known to the crowdsourcing service 121 as such, or can be specifically identified by the task owner. In another embodiment, the trusted human workers 130 can be selected by the task owner, such as when the task owner communicates to them a link, or other identifier, by which they can interface with the crowdsourcing service 121 as trusted workers. Irrespective of their method of selection, the trusted workers 130 can be less expensive, such as to the task owner or the crowdsourcing service 121, than the above referenced “specialists” that are typically utilized to generate reference intelligence tasks. Consequently, the mechanisms described herein, whereby reference intelligence tasks are automatically generated without utilizing such specialists, can result in substantial cost savings and efficiency improvements.

As intelligence tasks are provided to the trusted human workers 130, graphically illustrated as a set of tasks 161 in FIG. 1, results 163 can be received from the trusted human workers 130. In one embodiment, as illustrated by the arrow 170, the results 163 can be utilized by the crowdsourcing service 121 to automatically generate reference intelligence tasks, which can then be subsequently utilized, such as in the manner described in detail below. More specifically, in one embodiment, an intelligence task can be provided to multiple ones of the trusted human workers 130. The results 163 can indicate whether those human workers, to whom such an intelligence task was provided, reached a consensus as to what is the correct answer for such an intelligence task. A consensus as to the correct answer for an intelligence task can be reached if, as one example, greater than half of the trusted human workers, to whom such an intelligence task was assigned, determined the same answer. As another example, a consensus as to the correct answer for an intelligence task can be reached if all of the trusted human workers, to whom such an intelligence task was assigned, determined the same answer. Other thresholds between the two examples provided can, likewise, be utilized to establish the reaching of a consensus as to a correct answer for an intelligence task.

In one embodiment, an intelligence task can initially be provided to a predetermined number of the trusted human workers 130, and the results 163 from those workers can be examined to determine whether a consensus, as to the correct answer to such an intelligence task, was reached. If a consensus was not reached, then the intelligence task can be provided to an increasingly greater number of the trusted human workers 130, and the results 163 from those additional workers can be examined to determine whether a consensus, among all of the trusted human workers who have performed the intelligence task, has been reached. If no consensus is reached, and the intelligence task has already been provided to a threshold the number of the trusted human workers 130, then a determination can be made that such an intelligence task is not appropriate as a reference intelligence task. Conversely, if a consensus as to the correct answer to an intelligence task is reached, either from the initial trusted human workers that were provided such an intelligence task, or from a greater set of trusted human workers that include both the initial trusted human workers and the subsequent trusted human workers to which such intelligence task was subsequently assigned due to a consensus not having previously been reached, then a determination can be made that such an intelligence task is a reference intelligence task and the consensus answer can be associated with such a reference intelligence task. Such determinations can be part of the automated selection of reference intelligence tasks represented by the arrow 170 in FIG. 1.

As will be recognized by those skilled in the art, intelligence tasks can be assigned to human workers in a randomized manner. Consequently, descriptions herein referring to the provision or assignment of intelligence tasks to multiple human workers, including ones of the trusted human workers 130 and the human workers 140, are not meant to suggest or imply sequential intelligence task assignment, or concurrent intelligence task assignment. Rather, the assignment of intelligence tasks described herein refers merely to the providing, in aggregate, of one or more specific intelligence tasks to multiple human workers over a finite, though potentially undefined, period of time.

In one embodiment, in addition to obtaining the results of the performance of an intelligence task by a human worker, the crowdsourcing service 121 can, as part of the automated generation of reference intelligence tasks, also obtain classifications, from the trusted human workers to whom an intelligence task was assigned, classifying the intelligence task into one or more of predefined categories. Such categories can be specified by the task owner, such as part of the communication 152, or they can be automatically specified by the crowdsourcing service 121. The categorization of reference intelligence tasks can result in discrete groupings of reference intelligence tasks, organized by intended, or optimal, utilization of such reference intelligence tasks in the subsequent performance of the remainder of the intelligence tasks, such as by the human workers 140. For example, in one embodiment, categorization for reference intelligence tasks can include a “preview” categorization, a “qualification” categorization, a “spam” categorization and a “real-time audit” categorization.

In such an embodiment, reference intelligence tasks assigned to the preview categorization can be those intelligence tasks that the trusted workers 130, to whom such intelligence tasks were assigned, felt would be suitable intelligence tasks by which the overall set of intelligence tasks 151 could be previewed to individual ones of the human workers 140 seeking to determine whether they would desire to work on such tasks. Similarly, reference intelligence tasks assigned to the qualification categorization can be those intelligence tasks that the trusted workers 130, to whom such intelligence tasks were assigned, felt would be suitable intelligence tasks by which individual ones of the human workers 140 can be evaluated to determine whether such individual ones of the human workers 140 are appropriate to work on the intelligence tasks 183, which can be the remaining human intelligence tasks, from among the human intelligence tasks 151, that were not part of the automatically identified reference intelligence tasks 181. Reference intelligence tasks assigned to the spam categorization can be those reference intelligence tasks that were thought, such as by the ones of the trusted workers 130 to which they were assigned, to be reference intelligence tasks that were suitable for identifying whether the individual ones of the human workers 140 that are currently working on the intelligence tasks 183 are, in fact, applying human intelligence, instead of simply executing an automated algorithm on their computing device, and, thereby, deceptively seeking to obtain compensation for the application of human intelligence when no such human intelligence is being applied. Lastly, to complete the example, reference intelligence tasks assigned to the real-time audit categorization, can be those reference intelligence tasks that were deemed to be suitable, such as by those of the trusted human workers 130 to which such intelligence tasks were assigned, for correcting the work being performed by those of the human workers 140 that are being assigned intelligence tasks from among the intelligence tasks 183. More specifically, such real-time audit reference intelligence tasks can be periodically provided to those of the human workers 140 that are working on ones of the intelligence tasks 183 in order to verify that such human workers are providing correct results or, alternatively, if they are not providing correct results, to enlighten such human workers as to what is considered to be a correct result and to provide education as to why such a result is considered to be a correct result.

In one embodiment, categorization statistics can be provided to guide the trusted workers 130 in their determination of the classifications of those intelligence tasks that are assigned to them, and which the crowdsourcing service 121 is attempting to establish as reference intelligence tasks 181. For example, in addition to obtaining an answer, from an individual one of the trusted workers 130 to whom an intelligence task was assigned, the crowdsourcing service 121 can also request that such a trusted worker assign a categorization to such an intelligence task. The trusted worker can be provided with statistics indicating, for example, which categories of reference intelligence tasks still require further reference intelligence tasks. Thus, for example, if the task owner had requested that the automatic generation of reference intelligence tasks generate fifty reference intelligence tasks that can be utilized for preview purposes and another fifty reference intelligence tasks that can be utilized for qualification purposes, a trusted worker performing work on a specific intelligence task can be requested to categorize such an intelligence task as either a preview intelligence task or a qualification intelligence task, and can be further informed that forty intelligence tasks categorized as preview intelligence tasks are still required but that only five intelligence tasks categorized as qualification intelligence tasks are still required. Such categorization statistics can guide the trusted workers 130 in their determination of the classification of an intelligence task because, as will be recognized by those skilled in the art, often intelligence tasks can be equally categorizeable into multiple categories, and while a trusted worker may categorize an intelligence task as a preview intelligence task, such a trusted worker may have felt that the intelligence task was equally categorizeable as a qualification intelligence task. In such an instance, the presentation of categorization statistics can cause the trusted worker to categorize intelligence tasks, where the trusted worker was otherwise ambivalent as between two or more categorizations, to that category most in need of additional reference intelligence tasks.

In another embodiment, the guidance provided to the trusted workers 130, regarding categorization of the intelligence tasks, can be more direct. For example, if the reference intelligence tasks categorized in a given category have already met a threshold quantity of reference intelligence tasks requested for such a category, then such a category can no longer be presented to the trusted workers 130, thereby forcing the trusted workers 130 to categorize the remaining intelligence tasks on which they work into one of the remaining categories. As another example, those categories to which additional reference intelligence tasks should be assigned can be indicated in a manner that is more noticeable to the trusted workers 130 such as, for example, by indicating such categories utilizing a bold font, highlighting, priority placement, with such categories appearing ahead of other categories, or other like user interface cues.

In addition, or alternatively, the trusted workers 130 can be provided with descriptive guidance as to how to select, such as from the options identified above, a categorization for the intelligence task for which they have provided an answer, and which is intended to be utilized as a reference intelligence task. In one embodiment, the trusted workers 130 can be provided with a categorization interface that can associate complexities of tasks with suggested categorizations. For example, the trusted workers 130 can be informed that intelligence tasks that the trusted workers 130 felt were of simple complexity would be appropriate to categorize as spam detection intelligence tasks. As another example, the trusted workers 130 can be informed that intelligence tasks that the trusted workers 130 felt were of a medium complexity would be appropriate to categorize as either qualification test intelligence tasks or preview intelligence tasks. To complete the example, the intelligence workers 130 can be informed that the intelligence tasks that the trusted workers 130 felt were of a hard complexity would be appropriate to categorize as real-time audit intelligence tests. In another embodiment, rather than providing guidance to the trusted workers 130, the crowdsourcing service 121 can simply receive a complexity assessment from the trusted workers 130 and can automatically categorize the intelligence tasks based upon the complexity assessment received. For example, intelligence tasks that the trusted workers 130 categorize as having an easy complexity can be automatically categorized, by the crowdsourcing service 121, into the spam detection intelligence task category. As another example, intelligence tasks that the trusted workers 130 categorize as having a hard complexity can be automatically categorized, by the crowdsourcing service 121, into the real-time audit intelligence task category. If the trusted workers 130 categorize an intelligence task as having a medium complexity, the crowdsourcing service 121 can automatically categorize such intelligence tasks into either the qualification test category or the preview category, and selection as between those two categories can be based on other factors, such as, for example, whichever of those two categories are most deficient in intelligence tasks, as compared with a requested quantity of intelligence tasks for those two categories.

As with the determination of whether an intelligence task is to be a reference intelligence task, the categorization assigned to the reference intelligence task can be based on an achieving of consensus among those of the trusted workers 130 that had such an intelligence task assigned to them. More specifically, if those of the trusted workers 130 that had an intelligence task assigned to them had reached a consensus as to a correct answer to the intelligence task, then such an intelligence task, as detailed above, can be considered to be a reference intelligence task. In one embodiment, therefore, if those same trusted workers, whose consensus as to a correct answer had caused an intelligence task to be considered as a reference intelligence task, had also reached a consensus as to the categorization to be applied to such an intelligence task, than such a reference task can be so categorized. If, however, those same trusted workers, whose consensus as to a correct answer had caused an intelligence task to be considered as a reference intelligence task, had not reached a consensus as to the categorization of the intelligence task then, in one embodiment, additional ones of the trusted workers 130 can have such an intelligence task assigned to them and a determination can be made as to whether a consensus is not subsequently reached on the categorization of such intelligence task.

Alternatively, in another embodiment, rather than assigning the intelligence task to additional ones of the trusted workers 130, an automated categorization can be applied. Such an automated categorization can be based on the number of the trusted workers 130 assigning a particular categorization to an intelligence task, a priority of categorizations, a quantity of intelligence tasks still needed for a given categorization, comments provided by the trusted workers 130 in performing the intelligence task, including specific keywords or other like heuristic analysis of comments, or combinations thereof. Thus, as one example, if a consensus was achieved as to a correct answer for an intelligence task, but a consensus was not reached as to its categorization, an automated categorization can be applied and the intelligence task can be categorized into whichever categorization the most number of the trusted workers, to whom such an intelligence task was assigned, indicated the intelligence task should be categorized. As another example, automated categorization can categorize an intelligence task in accordance with whichever category is most lacking in reference intelligence tasks. As yet another example, automated categorization can categorize an intelligence task in accordance with whichever category is most highly ranked, so long as such a category does not yet have a full complement of reference intelligence tasks assigned to it. In one embodiment, automatic categorization can categorize an intelligence task into any category, while, in another embodiment, automatic categorization can be limited to selecting as among the categories explicitly identified by those of the trusted workers 130 to whom the intelligence task been assigned.

As will be recognized by those skilled in the art, some utilizations of reference intelligence tasks can require description as to why a particular answer is deemed to be the correct answer. For example, in performing a real-time audit, it can be helpful to explain to a worker why the answer that worker selected was incorrect, and why a particular answer is deemed to be the correct answer. Absent such an explanation, the real-time audit can be less helpful as it does not educate a worker as to why they were selecting an answer that was deemed to be incorrect. Therefore, in one embodiment, some or all of the categorizations can request or require that the trusted workers indicating that an intelligence task is to be assigned to such a categorization also provide a description as to why the trusted worker selected the answer that they selected. In such an embodiment, upon receiving the results 163, and as part of the automatic generation of reference intelligence tasks indicated by the arrow 170, the crowdsourcing service 121 can verify that the trusted workers 130 provided description for their answers where such a description was requested or necessary. If the crowdsourcing service 121 determines that such a description was not provided, the crowdsourcing service 121 can refuse to accept those of the results 163 lacking such a description. In an alternative embodiment, the crowdsourcing service 121 can enforce description requirements only if the crowdsourcing service 121 determines that the intelligence task in question will be deemed to be a reference intelligence task because consensus was reached as to the correct answer.

Once a set of reference intelligence tasks, such as exemplary set of reference intelligence tasks 181 are automatically generated, as illustrated by the arrow 170, the crowdsourcing service 121 utilized such reference intelligence tasks 181 to facilitate and improve the processing, such as by the workers 140, of the rest of the intelligence tasks 183, from among the intelligence tasks 151 that were provided by the task owner, which were not otherwise already processed as part of the automatic generation of the reference intelligence tasks 181. Thus, as illustrated in the exemplary system 100 of FIG. 1 by the communications 182 and 184, the reference intelligence tasks 181 and the rest of the intelligence tasks 183, respectively, can be utilized with the human workers 140 to obtain human processed results to the intelligence tasks, which results can be returned to the crowdsourcing service 121, as illustrated by the communication 185. The utilization of the reference intelligence tasks 181 to facilitate and improve the processing, by the workers 140, of the rest of the intelligence tasks 183 can by performed in a traditional manner known to those skilled in the art. Upon receiving, via the communication 185, the results of the human processing of the intelligence tasks 183, the crowdsourcing service 121 can provide such results to the task owner, as illustrated by the communication 159.

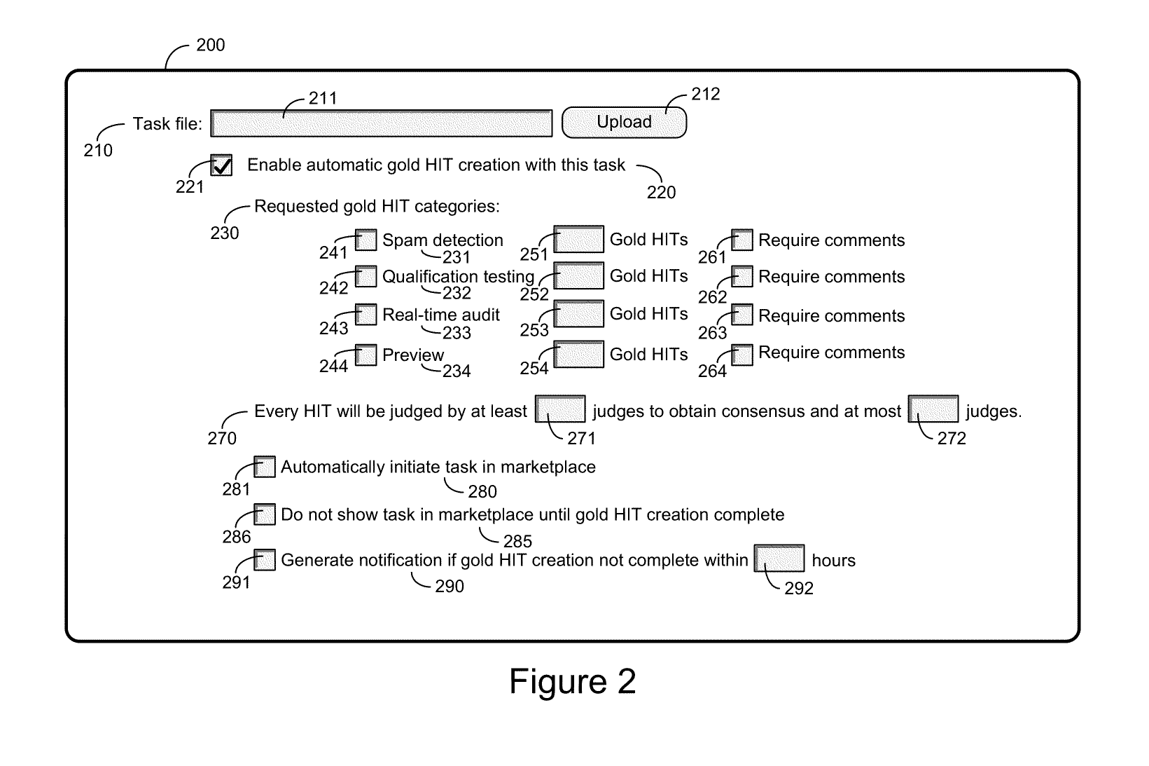

Turning to FIG. 2, the exemplary user interface 200 shown therein illustrates an exemplary user interface by which a task owner can establish parameters and guidelines and can otherwise frame the automatic generation of reference intelligence tasks. For example, exemplary user interface 200 can comprise a mechanism 210 by which the task owner can specify the tasks that the task owner seeks to have performed by humans in a crowdsourcing paradigm. The mechanism 210 can include the user entry area 211, by which the task owner can specify the tasks, such as the link to one or more files, and can include a trigger mechanism 212 by which the task owner can provide such tasks to the crowdsourcing service.

In one embodiment, the exemplary user interface 200 can comprise an automatic reference intelligence task generation mechanism 220 that a task owner can invoke via the selection user interface element 221. Should the task owner select the automatic reference intelligence task generation mechanism 220, such as via the selection user interface elements 221, a set of reference intelligence tasks can be generated, such as in the manner described in detail above. A task owner can, optionally, be provided with functionality through which the task owner can specify parameters of the above-described processing. For example, as illustrated by the exemplary user interface 200, a parameter specification mechanism 270 can enable the task owner to specify an initial number of trusted workers to whom an intelligence task can be presented and a subsequently greater number of trusted workers to whom the intelligence task can be further presented in an effort to achieve consensus on an answer to the intelligence task, if the initial number of trusted workers did not achieve such a consensus. Such quantity specifications can be made via the user entry areas 271 and 272, respectively. As detailed above, an intelligence task can initially be provided to the number of trusted workers indicated via the user entry area 271 and, if a consensus as to a correct answer to the intelligence task does not emerge from such an initial set of trusted workers, the number of trusted workers to whom the intelligence task is provided can increase in an effort to obtain consensus until a maximum number of trusted workers is reached, as specified via the user entry area 272.

In one embodiment, a categorization mechanism 230 can enable a task owner to identify specific categories of reference intelligence tasks that the task owner desires to have automatically generated. As indicated previously, such categories can be based on intended utilizations of the reference intelligence tasks. Thus, for example, exemplary user interface 200 illustrates four exemplary categories of reference intelligence tasks, including a spam detection category 231, a qualification testing category 232, a real-time audit category 233 and a preview category 234. Each category can be associated with a corresponding selection user interface element, namely the selection user interface elements 241, 242, 243 and 244, respectively, which can enable a task owner to independently select one or more of the categories 231, 232, 233 and/or 234, respectively. In addition, for each of the categories 231, 232, 233 and 234, user entry areas 251, 252, 253 and 254, respectively, can enable a task owner to specify a quantity, such as a minimum quantity, of reference intelligence tasks that are to be automatically generated within each of the corresponding categories. In one embodiment, a task owner can specify percentages in the user entry areas 251, 252, 253 and 254, while in another embodiment the task owner can specify raw quantities in the user entry areas 251, 252, 253 and 254.

As indicated previously, in one embodiment, trusted workers can be requested, as part of the automatic generation of reference intelligence tasks, to provide comments explaining why they selected a particular answer. The exemplary user interface 200, shown in FIG. 2, therefore includes selection user interface elements 261, 262, 263 and 264 by which a task owner can explicitly request that comments be provided explaining the answers given by the trusted workers for intelligence tasks categorized into the categories 231, 232, 233 and 234, respectively.

In addition to enabling a task owner to request automatic generation of reference intelligence tasks, and enabling a task owner to set relevant parameters in the automatic generation of such reference intelligence tasks, the exemplary user interface 200 shown in FIG. 2 can further present, to the task owner, options associated with the automatic generation of reference information. For example, the option 280 can enable a task owner to instruct the crowdsourcing system to automatically initiate the performance of the task, by the workers that make up the crowdsourcing system, once the reference intelligence tasks are generated, and without any explicit further authorization from the task owner. Selection of the option 280, such as via the selection user interface element 281, can enable a task owner to perform a single action, namely the provision of the task that they seek to have crowdsourced, and the crowdsourcing system can then automatically perform the remaining steps, including automatically generating reference intelligence tasks, as detailed above, and then utilizing such automatically generated reference intelligence tasks to improve and optimize the performance of the task by the crowdsourcing system. Conversely, should the task owner choose not to select the option 280, in one embodiment, upon completion of the automatic generation of reference intelligence tasks, a subsequent user interface can be provided, such as to the task owner, through which the task owner can be presented with information regarding the automatically generated a reference intelligence tasks. For example, such a subsequent user interface can provide, to the task owner, information regarding a quantity of reference intelligence tasks that were generated, a categorization of the automatically generated reference intelligence tasks, comments provided by the trusted workers in generating the reference intelligence task, and other like information. The task owner can then, in one embodiment, manually select those of the automatically generated reference intelligence tasks that the task owner desires to have utilized to improve the crowdsourced processing performed on the intelligence tasks that are provided by the task owner.

Exemplary option 285, illustrated in the exemplary user interface 200 of FIG. 2, can enable a task owner to delay the presentation of the task to workers that are not trusted workers until the automatic creation of the reference intelligence tasks is complete. As with the other options, the exemplary option 285 can be selected by the task owner via the selection user interface element 286.

In one embodiment, to avoid situations where, due to the nature of the intelligence tasks, the trusted workers, or combinations thereof, the automatic generation of reference intelligence tasks becomes bogged down in a repeating loop or is otherwise inefficiently being performed, the exemplary user interface 200 can comprise an option 290 by which the crowdsourcing system can generate a notification if the automatic generation of reference intelligence tasks is taking too long. As illustrated in FIG. 2, such an option 290 can be selected, by the task owner, via the selection user interface element 291. Additionally, a user entry area 292 can enable the task owner to specify a threshold period of time after which indicated notification is to be generated. Other notifications can also be provided to a task owner and the exemplary user interface 200 can, likewise, provide the task owner with an option to enable or disable such notifications. For example, notification can be provided to the task owner if an insufficient quantity of intelligence tasks remains in order for the automatic generation of reference intelligence tasks to succeed in generating all of the requested reference intelligence tasks. As will be recognized by those skilled in the art, such a notification can save time by alerting the task owner at the first instance when it becomes mathematically impossible to complete the automatic generation of the reference intelligence tasks in the manner specified by the task owner.

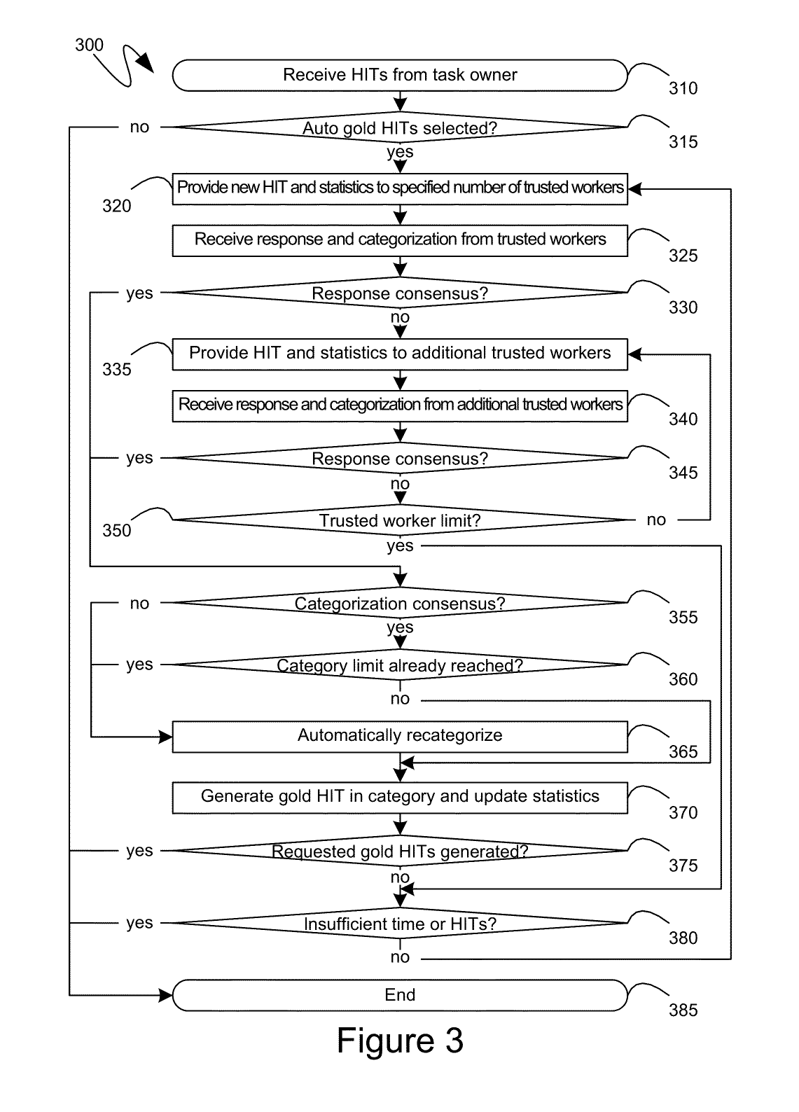

Turning to FIG. 3, the exemplary flow diagram 300 shown therein illustrates an exemplary series of steps by which reference intelligence tasks can be automatically generated. Initially, as illustrated by step 310, a task owner can provide a task, that can be comprised of a myriad of individual intelligence tasks that are to be performed by the application of human intelligence, such as through a crowdsourcing paradigm. Subsequently, at step 315, a determination can be made as to whether the task owner has requested that reference intelligence tasks be automatically generated. If, at step 315, it is determined that the task owner has not requested that reference intelligence tasks be automatically generated, then the relevant processing can end at step 385, as shown by the exemplary flow diagram 300 of FIG. 3. Conversely, if, at step 315, it is determined that the task owner did request that reference intelligence tasks be automatically generated, processing can proceed with step 320, where an intelligence task can be provided to a specified number of trusted workers. As detailed above, such a specified number of trusted workers can be specified by the task owner, or can be automatically selected. As also detailed above, while step 320 is illustrated as a single step, those of skill in the art will recognize that the provision of intelligence tasks occurs in a randomized manner to disparate individuals, including individual ones of the trusted workers. Consequently, step 320 is not meant to represent an explicit single step, but rather the aggregate provision, over a period of time, of an intelligence task to a determined quantity of trusted workers.

At step 325, responses can be received from the trusted workers to whom the intelligence task was provided as part of step 320. As indicated previously, the responses, received at step 325, can comprise answers to the intelligence task, as determined by the individual ones of the trusted workers, as well as those workers' categorizations of the intelligence task, if appropriate. At step 330, a determination can be made as to whether the answers received at step 325 evidence a consensus among the trusted workers whose answers were received at step 325. If, at step 330, it is determined that there is a consensus as to the correct answer, then processing can proceed with step 355. Conversely, if, at step 330, it is determined that a consensus has not been reached as to the correct answer, then processing can proceed to step 335 and the intelligence task can be provided to additional trusted workers. The response from those additional trusted workers to whom the intelligence task was provided at step 335, can be received 340. At step 345, another determination can be made as to whether the answers provided by the trusted workers at step 325, combined with the answers provided by the trusted workers at step 340, now evidence a consensus as to the correct answer. If, at step 345, a consensus as to the correct answer has now been reached, than processing can proceed with step 355. Conversely, if, step 345, no consensus as to the correct answer has yet been reached, a subsequent determination can be made at step 350 as to whether the intelligence task has already been provided to a maximum number of trusted workers. If, at step 350, it is determined that the maximum number of trusted workers have already received the intelligence task, then that intelligence task may not be appropriate for identification as a reference intelligence task and, consequently, processing can proceed to step 380. Conversely, if, at step 350, it is determined that the maximum number of trusted workers have not already received the intelligence task, then processing can return to step 335, and additional ones of the trusted workers can be provided with the intelligence task. Their responses can be received at step 340, and step 345 can again be performed to determine whether now, with the additional responses received at step 340, there is a consensus as to the correct answer. Subsequent processing can proceed as already described until either a consensus is reached or a maximum number of trusted workers have already provided responses to the information task.

Returning back to steps 330 and 345, if, at steps 330 or 345, it is determined that a consensus has been reached as to the correct answer to the intelligence task, based upon the results received from the trusted workers, such as at step 325 and, optionally, at step 340, than processing can proceed to step 355, as illustrated by the exemplary flow diagram 300 of FIG. 3. At step 355, a determination can be made as to whether the responses from the trusted workers evidence a consensus as to the categorization to be applied to the intelligence task. If, at step 355, it is determined that a consensus exists as to the categorization of the intelligence task, a subsequent check, at step 360, can determine whether a threshold limit number of intelligence tasks have already been categorized into that category. If, at step 360, it is determined that the consensus category can still have additional intelligence tasks categorized into it, than processing can proceed to step 370 where the intelligence task can be identified, or generated, as a reference intelligence task and can be categorized into the consensus category, as identified by the responses that were received from the trusted workers who have provided responses to such an intelligence task. Additionally, as part of step 370, relevant statistics, such as the quantity of reference intelligence tasks already categorized into each of the categories, and a total amount of reference intelligence tasks that are desired for each of the categories, can be generated.

Returning back to step 355, if, at step 355, the responses received from the trusted workers evidence a consensus as to the correct answer, but do not evidence a consensus as to a categorization of the intelligence task, processing can, in one embodiment, proceed to step 365 where such an intelligence task can be automatically categorized. Similarly, if, at step 360, the responses received from the trusted workers evidence a consensus as to the correct answer and as to a categorization of the intelligence task, but the selected categorization is already full and no longer needs to have any additional intelligence tasks categorized to it, then processing can again proceed to step 365 and the intelligence task can be automatically recategorized. As indicated previously, in one embodiment, the automatic re-categorization, such as at step 365, can select a categorization based upon factors including a prioritization of categories, and, such as which categories are most deficient in quantity of reference intelligence tasks, trusted worker selections, combinations thereof. For example, in one embodiment, a categorization priority can assign a highest priority to qualification reference intelligence tasks, then, in order of decreasing priority, spam detection reference intelligence tasks, real-time audit reference intelligence tasks and, finally, preview reference intelligence tasks, which can even be optional. Additionally, as also indicated previously, in one embodiment, the automatic re-categorization, such as at step 365, can be limited to selecting from among the categories that were explicitly indicated by at least one of the trusted workers providing a response, such as at step 325 or at step 340. Once a reference intelligence task is recategorized, such as at step 365, processing can proceed to step 370, where, as indicated previously, an intelligence task can be identified or generated as a reference intelligence task and can be categorized, and the relevant statistics can be updated.

Subsequent to step 370, as illustrated by the exemplary flow diagram 300 of FIG. 3, a determination can be made, such as at step 375, as to whether additional reference intelligence tasks should be generated, such as, for example, if the quantity of currently generated reference intelligence tasks is below threshold amounts specified by the task owner. If it is determined, at step 375, that no further reference intelligence tasks need to be generated, then the relevant processing can end at step 385. Conversely, if, at step 375, it is determined that additional reference intelligence tasks should be identified and generated, then processing can proceed to step 380, where a determination can be made as to whether a sufficient quantity of time and a sufficient quantity of intelligence tasks remain. As indicated previously, in one embodiment, to ensure efficient automatic generation of reference intelligence tasks, the task owner can set a threshold time limit by which such a task owner should be notified if the requested quantity of reference intelligence tasks has not yet been generated. Consequently, in such an embodiment, at step 380, a determination can be made as to whether such a threshold time limit has been reached. If the threshold time limit has not been reached, then processing can return to step 320 and proceed as described above. Conversely, if, at step 380, it is determined that the threshold time limit has been reached, then the relevant processing can end at step 385 and the task owner can be appropriately notified. Similarly, as also indicated previously, in one embodiment, to ensure that the task owner is notified at the first instance when it becomes mathematically impossible to complete the automatic generation of the reference intelligence tasks in the manner specified by the task owner, the task owner can be notified when an insufficient quantity of intelligence tasks remains to complete the automatic generation of reference intelligence tasks in the manner specified by the task owner. Consequently, in such an embodiment, at step 380, a determination can be made as to whether is sufficient quantity of intelligence tasks remains given the parameters of the automatic generation of reference intelligence tasks that were specified by the task owner. If, at step 380, it is determined that a sufficient quantity of intelligence tasks remains, then processing can return to step 320 and proceed as described above. Conversely, if, at step 380, it is determined that an insufficient quantity of intelligence tasks remains, then the relevant processing can end at step 385 and the task owner can be appropriately notified.

Although not specifically illustrated in the exemplary flow diagram 300 of FIG. 3, as such an exemplary flow diagram is primarily directed to the automatic generation of reference intelligence tasks, once inappropriate quantity of reference intelligence tasks is automatically generated, such reference intelligence tasks can be automatically utilized as part of the crowdsourced processing performed on the intelligence tasks provided by a task owner. As indicated previously, such as in reference to FIG. 2 above, such automatic utilization the automatically generated reference intelligence tasks can be delayed until all requested reference intelligence tasks are automatically generated, or can commence while the automatic generation of reference intelligence tasks remains ongoing. Consequently, with reference to the exemplary flow diagram 300 of FIG. 3, in an embodiment where utilization of the automatically generated reference intelligence tasks can commence while the automatic generation of such reference intelligence tasks is ongoing, then, in such an embodiment, the generation of the reference intelligence tasks, at step 370, can lead to a subsequent step, not explicitly shown, where the reference intelligence tasks generated at step 370 are utilized in the crowdsourced processing performed on the intelligence tasks provided by a task owner. Conversely, in an embodiment where the utilization of the automatically generated reference intelligence tasks is delayed until the automatic generation of such reference intelligence tasks is complete, then, in such an embodiment, the end of the automatic generation of reference intelligence tasks, at step 385, can lead to subsequent steps where such automatically generated reference intelligence tasks are utilized in the crowdsourced processing performed on the intelligence tasks provided by a task owner.

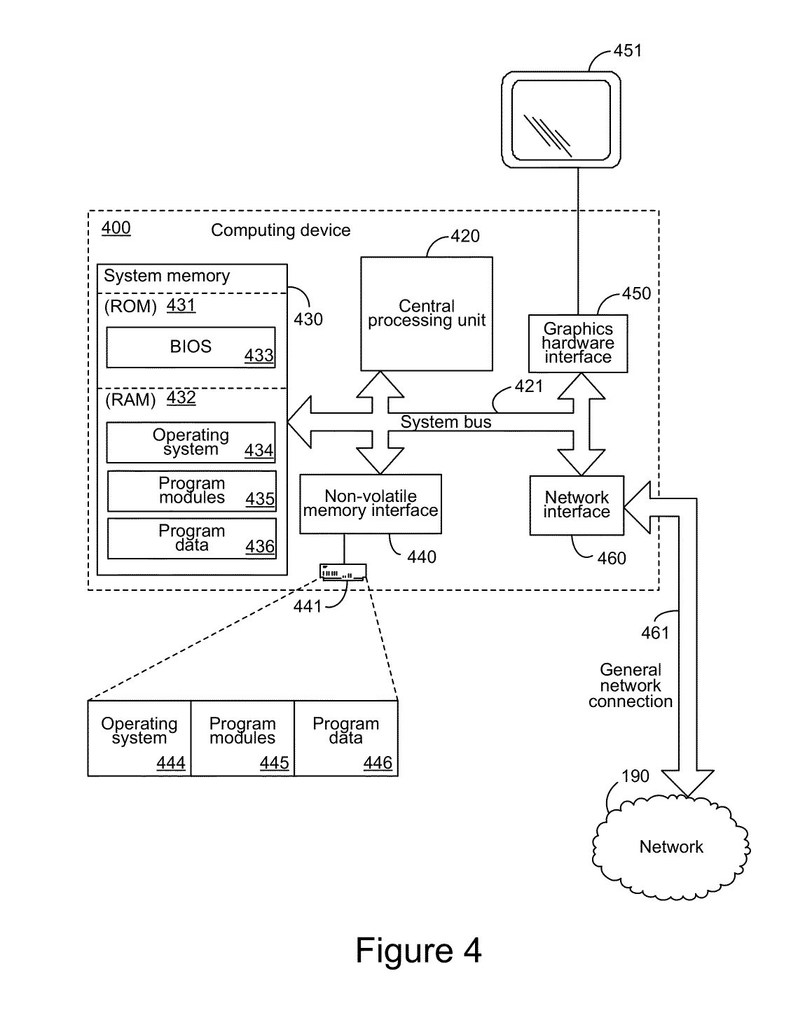

Turning to FIG. 4, an exemplary computing device 400 is illustrated which can perform some or all of the mechanisms and actions described above. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 450 and a display device 451, which can include display devices capable of receiving touch-based user input, such as a touch-sensitive, or multi-touch capable, display device. Depending on the specific physical implementation, one or more of the CPUs 420, the system memory 430 and other components of the computing device 400 can be physically co-located, such as on a single chip. In such a case, some or all of the system bus 421 can be nothing more than silicon pathways within a single chip structure and its illustration in FIG. 4 can be nothing more than notational convenience for the purpose of illustration.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-volatile memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

The computing device 400 may operate in a networked environment using logical connections to one or more remote computers. The computing device 400 is illustrated as being connected to the general network connection 461 through a network interface or adapter 460, which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 461. It will be appreciated that the network connections shown are exemplary and other means of establishing a communications link between computing devices may be used.

As can be seen from the above descriptions, mechanisms for automatically generating and utilizing reference intelligence tasks have been presented. In view of the many possible variations of the subject matter described herein, we claim as our invention all such embodiments as may come within the scope of the following claims and equivalents thereto.

We claim:

1. One or more computer-readable media comprising computer-executable instructions for generating reference human intelligence tasks, the computer-executable instructions directed to steps comprising:
obtaining a set of human intelligence tasks;
selecting a first human intelligence task from among the set of human intelligence tasks;
presenting the first human intelligence task to a predetermined first quantity of workers;
generating the first human intelligence task as a reference human intelligence task if greater than a first threshold quantity of workers, from among the predetermined first quantity of workers, identified a same answer to the first human intelligence task;
presenting the first human intelligence task to additional workers, not exceeding a predetermined second quantity of workers, if a maximum number of workers of the predetermined first quantity of workers that identified the same answer to the first human intelligence task was less than the first threshold quantity of workers; and
generating the first human intelligence task as a reference human intelligence task if greater than a second threshold quantity of workers, from among the predetermined first quantity of workers combined with the additional workers, identified the same answer to the first human intelligence task.

2. The computer-readable media of claim 1, wherein the predetermined first quantity of workers and the predetermined second quantity of workers are user-provided.

3. The computer-readable media of claim 1, wherein the computer-executable instructions for generating the reference human intelligence task comprise computer-executable instructions for assigning the reference human intelligence task to a category of utilization.

4. The computer-readable media of claim 3, wherein the category of utilization to which the reference human intelligence task is assigned was selected by greater than a third threshold quantity of the predetermined first quantity of workers or, if the first human intelligence task was presented to the additional workers, by greater than a fourth threshold quantity of workers from among the predetermined first quantity of workers combined with the additional workers.

5. The computer-readable media of claim 3, comprising further computer-executable instructions for selecting the category of utilization to which the reference human intelligence task will be assigned based at least upon a prioritization of categories of utilization.

6. The computer-readable media of claim 3, comprising further computer-executable instructions for:
receiving a user-specified threshold quantity of reference human intelligence tasks to be generated for of multiple categories of utilization; and
selecting the category of utilization to which the reference human intelligence task will be assigned based at least upon whichever of the multiple categories of utilization requires a greatest quantity of reference human intelligence tasks to be assigned to it so as to reach the user-specified threshold quantity of reference human intelligence tasks assigned to that category of utilization.

7. The computer-readable media of claim 3, wherein the computer-executable instructions directed to the presenting comprise computer-executable instructions directed to presenting information indicative of quantities of reference human intelligence tasks already assigned to each of multiple categories of utilization.

8. The computer-readable media of claim 1, comprising further computer-executable instructions for ceasing execution of the computer-executable instructions of claim 1 and generating a notification if a predetermined time limit has expired since commencement of execution of the computer-executable instructions of claim 1 and a requested quantity of reference human intelligence tasks have not yet been generated.

9. The computer-readable media of claim 1, comprising further computer-executable instructions for utilizing the generated reference human intelligence task in the crowdsourcing of results for a task that is associated with the set of human intelligence tasks.

10. A graphical user interface, physically generated on a display device by a computing device, the graphical user interface comprising:
a selection user interface element associated with an automatic creation of a set of reference human intelligence tasks;
a first user entry area by which a user can specify a first quantity of workers to initially receive a human intelligence task, wherein consensus among the first quantity of workers on a same answer to the human intelligence task results in the human intelligence task being generated as a reference human intelligence task in the set of reference human intelligence tasks; and
a second user entry area by which the user can specify a second quantity of workers limiting additional workers receiving the human intelligence task, wherein consensus among the first quantity of workers and the additional workers on the same answer to the human intelligence task results in the human intelligence task being generated as the reference human intelligence task in the automatically created set of reference human intelligence tasks.

11. The user interface of claim 10, further comprising:
an enumeration of categories of utilization into which reference human intelligence tasks, of the automatically created set of reference human intelligence tasks, can be assigned;
selection user interface elements by which a user can specify desired ones of the enumerated categories of utilization; and
user entry areas by which the user can specify a quantity of reference human intelligence tasks to be automatically created and assigned to the desired ones of the categories of utilization.

12. The user interface of claim 10, further comprising:
a selection user interface element by which the user can request notification if the automatic creation of the set of reference human intelligence tasks has not completed within a predefined time period; and
a user entry area by which the user can specify the predefined time period.

13. A method of generating reference human intelligence tasks, the method comprising the steps of:
obtaining a set of human intelligence tasks;
selecting a first human intelligence task from among the set of human intelligence tasks;
presenting the first human intelligence task to a predetermined first quantity of workers;
generating the first human intelligence task as a reference human intelligence task if greater than a first threshold quantity of workers, from among the predetermined first quantity of workers, identified a same answer to the first human intelligence task;
presenting the first human intelligence task to additional workers, not exceeding a predetermined second quantity of workers, if a maximum number of workers of the predetermined first quantity of workers that identified the same answer to the first human intelligence task was less than the first threshold quantity of workers; and
generating the first human intelligence task as a reference human intelligence task if greater than a second threshold quantity of workers, from among the predetermined first quantity of workers combined with the additional workers, each identified the same answer to the first human intelligence task.

14. The method of claim 13, wherein the generating the reference human intelligence task comprises assigning the reference human intelligence task to a category of utilization.

15. The method of claim 14, wherein the category of utilization to which the reference human intelligence task is assigned was selected by greater than a third threshold quantity of the predetermined first quantity of workers or, if the first human intelligence task was presented to the additional workers, by greater than a fourth threshold quantity of workers from among the predetermined first quantity of workers combined with the additional workers.

16. The method of claim 14, further comprising the steps of: selecting the category of utilization to which the reference human intelligence task will be assigned based at least upon a prioritization of categories of utilization.

17. The method of claim 14, further comprising the steps of:
receiving a user-specified threshold quantity of reference human intelligence tasks to be generated for each of multiple categories of utilization; and
selecting the category of utilization to which the reference human intelligence task will be assigned based at least upon whichever of the multiple categories of utilization requires a greatest quantity of reference human intelligence tasks to be assigned to it so as to reach the user-specified threshold quantity of reference human intelligence tasks assigned to that category of utilization.

18. The method of claim 14, wherein the presenting comprises presenting information indicative of quantities of reference human intelligence tasks already assigned to each of multiple categories of utilization.

19. The method of claim 13, further comprising the steps of: ceasing performance of the steps of claim 1 and generating a notification if a predetermined time limit has expired since commencement of the performance of the steps of claim 1 and a requested quantity of reference human intelligence tasks have not yet been generated.

20. The method of claim 13, further comprising the steps of: utilizing the generated reference human intelligence task in the crowdsourcing of results for a task that is associated with the set of human intelligence tasks.
